(19) United States
(12) Patent Application Publication
(10) Pub. No.: US 2003/0047088 A1
(43) Pub. Date: Mar. 13, 2003

(54) Squeeze garlic

(76) Inventor: Eduardo J. Pardey, Miami, FL (US)

Correspondence Address: EDUARDO J. PARDEY, 10357 SW 9th TERRACE, MIAMI, FL, 33174, US

(21) Appl. No.: 09/876,060

(22) Filed: Sep. 12, 2001

(51) Int. Cl. B30B 7/00

(52) U.S. Cl. 100/234

(57) ABSTRACT

My invention is a devise used to squish garlic cloves, separate the skin from the inside, and maintain the juices in order to use for marinating different foods. My devise comes in different colors, it is heat resistant, it seals in the garlic odors, and maintains your hands clean and free of odors, it is light, and very manual. This devise is safe, and easy to use even by a small child.

I feel my devise is unique. I have not seen any other garlic squishier such as mine.

### As requested by your Organization in your letter dated Aug. 7, 2001. I have included in this letter the following:

1—Invention Specification

2—Invention claim

3—Additional Oath or Declaration

4—$130.00 petition fee

### SPECIFICATION

The invention is a garlic squishier. The garlic squishier is composed of five components or five separate pieces, when put together form the garlic squishier. The material used to fabricate the invention is Hi Plastic, which is injected at high impact. This material is non-toxic, and can be exposed to extremely high temperatures. The material maintains its original color, and is available in many shades.

The garlic squishier is composed of five separate components or pieces as specified below.

1—A tourniquet or type of screw component, which pushes the garlic through the main chamber.

2—A chamber or body of the invention, where the garlic clove is inserted, and where the tourniquet pushes the garlic clove through this chamber.

3—The strainer allows the squished garlic, and juices to pass the holes, while keeping the garlic skin inside the chamber.

4—Two caps, one on each side of the main body (chamber), which seals in garlic orders, in order to prevent garlic orders to invade your refrigerator.

5—The rotor is the mechanism which allows the tourniquet to push the garlic clove through the chamber, without it getting jammed in the process.

The garlic squishier is safe to put in your dishwasher, in your refrigerator, can be exposed to high temperatures, and can come in an assortment of colors.

1. Under the Specifications I have outlined and explained in layman words how my invention works. I did not rely on any previous inventions of any kind. I only used my own ideas for the development and fabrication of my invention. I invented what I believe to be the best possible way to squish a garlic clove, to use as a tenderizer, and condiment to make the foods I like to eat more tasteful to me.
